(19) United States
(12) Patent Application Publication
(10) Pub. No.: US 2026/0227332 A1
(43) Pub. Date: Aug. 6, 2026

(54) Single-Molecule Fluorescence Detection System and Method

(71) Applicant: The University of Sheffield, Sheffield (GB)

(72) Inventors: Timothy David Craggs, Sheffield (GB); Benjamin Mark Ambrose, Sheffield (GB); Elliot McCallum Steele, Sheffield (GB)

(73) Assignee: The University of Sheffield, Sheffield (GB)

(21) Appl. No.: 19/632,714

(22) Filed: Mar. 30, 2026

Related U.S. Application Data
(63) Continuation of application No. PCT/GB2023/052526, filed on Sep. 29, 2023.

(51) Int. Cl. G01N 21/64

(52) U.S. Cl. CPC G01N 21/6428; G01N 21/6408; G01N 21/6452

(57) ABSTRACT

A solution-based single-molecule fluorescence spectroscopy system comprising: an excitation source for illuminating an excitation volume of a fluorescently labelled sample solution with excitation radiation; a detector for detecting fluorescence emission radiation emitted from a detection volume of the fluorescently labelled sample solution; one or more processors configured to: receive a detection signal from the detector; calculate a sample signal occupancy representing a proportion of time that the detection signal comprises a sample emission signal from the fluorescently labelled sample solution; and output a sample quality signal based on the sample signal occupancy.

### FIELD

The present disclosure relates to a solution-based single-molecule fluorescence spectroscopy system and a method of analysing sample quality of a sample for said system.

### BACKGROUND

Single-molecule Forster resonance energy transfer (smFRET) is a fluorescence technique for studying single molecules. smFRET can enable determination of different biomolecular conformations present in (dynamic) equilibrium, and the corresponding rates of conformational transitions, at timescales relevant to key cellular processes such as protein (un)folding, transcription and DNA replication and repair. Confocal experiments are also the approach of choice for generating multiple smFRET restraints for integrative structural modelling, due to the simple sample preparation, fast data acquisition, and high time resolution.

### SUMMARY

According to a first aspect of the present disclosure there is provided a solution-based single-molecule fluorescence spectroscopy system comprising:
an excitation source for illuminating an excitation volume of a fluorescently labelled sample solution with excitation radiation;
a detector for detecting fluorescence emission radiation emitted from a detection volume of the fluorescently labelled sample solution;
one or more processors configured to:
   receive a detection signal from the detector;
   calculate a sample signal occupancy representing a proportion of time that the detection signal comprises a sample emission signal from the fluorescently labelled sample solution; and
   output a sample quality signal based on the sample signal occupancy. The sample quality signal may comprise the sample signal occupancy.

The one or more processors may be configured to compare the sample signal occupancy to an upper occupancy threshold. The sample quality signal may comprise an alert signal if the sample signal occupancy exceeds the upper occupancy threshold.

The alert signal may comprise an indication that the sample signal occupancy is too high and/or a recommendation to dilute the fluorescently labelled sample solution.

The one or more processors may be configured to calculate a recommended dilution value based on the sample signal occupancy and wherein the alert signal indicates the recommended dilution value.

The system may be configured to lower a concentration of the fluorescently labelled sample solution if the sample signal occupancy exceeds the upper occupancy threshold. The system may comprise a microfluidics sample holder. The system may be configured to lower the concentration of the fluorescently labelled sample solution by increasing a flow of a first microfluidics supply line supplying a buffer solution and/or decreasing a flow of a second microfluidics supply line supplying fluorescently labelled molecules.

The system may be suitable for a multi-well sample, wherein different wells of the multi-well sample comprise different concentrations of fluorescently labelled sample solutions. The system may be configured to lower the concentration of the fluorescently labelled sample solution by positioning a well with a relatively low concentration sample solution in the excitation volume.

The one or more processors may be configured to compare the sample signal occupancy to a lower occupancy threshold. The sample quality signal may comprise an alert signal if the sample signal occupancy is less than the lower occupancy threshold.

The alert signal may comprise: an indication that the sample signal occupancy is too low; a recommendation to increase a concentration of the fluorescently labelled sample solution; and/or an indication that no fluorescence peaks have been detected.

The one or more processors may be configured to calculate the sample signal occupancy by:
dividing the detection signal into a plurality of time bins;
for each time bin, determine the time bin to comprise a sample emission signal from the fluorescently labelled sample if a signal level of the detection signal exceeds a sample identification threshold; and
determine the sample signal occupancy as the number of time bins comprising an emission signal divided by the total number of time bins in the plurality of time bins.

The one or more processors may be configured to:
perform a peak detection algorithm to identify one or more burst peaks of the detection signal corresponding to fluorescence emission from the fluorescently labelled sample;
determine a pulse width of each burst peak; and
determine the sample signal occupancy as the sum of the pulse widths divided by a time period of the detection signal.

The one or more processors may be configured to determine a fluorescence background level based on a signal level of a proportion of the detection signal that does not comprise a sample emission signal. The one or more processors may be configured to output the sample quality signal based on the sample signal occupancy and the background fluorescence level.

The one or more processors may be configured to:
divide the detection signal into a plurality of time bins;
for each time bin,
   determine the time bin to comprise a sample emission signal from the fluorescently labelled sample if a signal level of the detection signal exceeds a sample identification threshold; and
   determine the time bin to comprise a background signal if the signal level of the detection signal is less than or equal to the sample identification threshold;
determine the sample signal occupancy as the number of time bins comprising an emission signal divided by the total number of bins in the plurality of time bins;
determine a fluorescence background level based on an average signal level of the time bins comprising a background signal; and
output the sample quality signal based on the sample signal occupancy and the background fluorescence level.

The one or more processors may be configured to:
perform a peak detection algorithm to identify one or more burst peaks of the detection signal corresponding to fluorescence emission from the fluorescently labelled sample; and
determine a background fluorescence level based on an average signal level of regions of the detection signal that do not include a burst peak.

The sample quality signal may comprise the background fluorescence level.

The one or more processors may be configured to compare the fluorescence background level to a background level threshold. The sample quality signal may comprise a background alert signal if the fluorescence background level is greater than the background level threshold.

The background alert signal may comprise an indication that the fluorescence background level is too high and/or a recommendation to re-prepare the sample solution buffer.

The processor may be configured to output the sample quality signal on a continuous or semi-continuous basis.

According to a second aspect of the present disclosure there is provided a method of determining a sample quality of a fluorescently labelled sample solution in a single-molecule fluorescence spectroscopy system, the method comprising:
receiving a detection signal from the detector of the system;
calculating a sample signal occupancy representing a proportion of time that the detection signal comprises a sample emission signal from the fluorescently labelled sample solution; and
outputting a sample quality signal based on the sample signal occupancy.

According to a third aspect of the present disclosure there is provided a computer-readable medium comprising instructions which, when executed by one or more processors, cause the one or more processors to carry out any method disclosed herein.

There may be provided a computer program, which when run on a computer, causes the computer to configure any apparatus, including a circuit, controller, converter, or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### BRIEF DESCRIPTION OF THE DRAWINGS

One or more embodiments will now be described by way of example only with reference to the accompanying drawings in which:

FIG. 1 illustrates a simplified schematic of a solution-based single-molecule fluorescence spectroscopy system according to an embodiment of the present disclosure;

FIG. 2 illustrates an example detection signal output to a user interface of the system of FIG. 1;

FIG. 3 illustrates a method of determining a sample quality of a fluorescently labelled sample solution in a single-molecule fluorescence spectroscopy system according to an embodiment of the present disclosure; and

FIG. 4 illustrates another method of determining a sample quality of a fluorescently labelled sample solution in a single-molecule fluorescence spectroscopy system according to an embodiment of the present disclosure.

### DETAILED DESCRIPTION

FRET is a photophysical process which results in the transfer of excitation energy from a donor fluorophore to an acceptor fluorophore. The efficiency of this transfer process scales inversely with the sixth power of the distance between the two fluorophores. Therefore, by measuring the FRET efficiency (e.g. by observing the emission of the two fluorophores under excitation of the donor), spatial information can be determined in the 3-10 nm range, making FRET a ‘spectroscopic ruler’ well matched to the dimensions of biomolecules such as nucleic acids and proteins. In ensemble measurements this can be used to detect on-off/relative distance changes such as binding and cleaving in bimolecular interactions, or conformational changes (e.g. opening and closing) in unimolecular processes. At the single-molecule level, FRET is sensitive to heterogeneous subpopulations, can measure kinetics of processes at equilibrium, and absolute FRET efficiencies can be used to infer precise distances for biomolecular structure determination.

In a confocal smFRET experiment, the sample consists of fluorescently labelled molecules that are allowed to diffuse freely in solution. An excitation laser can be focused through an objective lens to a near diffraction-limited spot defining an excitation volume. Light emitted from this volume can be focused by a second objective (or the same objective) onto a pinhole that rejects light emitted from out of the focal plane of the objective lens, resulting in a detection volume in the sample from which fluorescence photons can be detected. The overlapping of the excitation volume and the detection volume defines a confocal volume-the region in space where a molecule can be excited and the resulting fluorescence emission detected. When a fluorescently labelled molecule diffuses into the confocal volume it will emit fluorescence emission radiation (i.e. light) which is collected and detected by the microscope's optics/detectors. The intensity of light detected (e.g. a photon count or intensity value) as the molecule diffuses through the confocal volume can be analysed to determine distances between the fluorophores attached to the molecule.

Molecules of interest are labelled with a donor and acceptor fluorophore, and the emitted light from these fluorophores are counted on separate detectors. In some examples, light with a wavelength greater than 650 nm may be recorded on the acceptor detector and light with a wavelength less than 650nm recorded on the donor detector.

Confocal smFRET experiments can reveal different biomolecular conformations present in (dynamic) equilibrium, and the corresponding rates of conformational transitions, at timescales relevant to key cellular processes such as protein (un)folding, transcription and DNA replication and repair. Confocal experiments are also the approach of choice for generating multiple smFRET restraints for integrative structural modelling, due to the simple sample preparation, fast data acquisition, and high time resolution.

Working at low concentrations of labelled species (~50 pM) can ensure only individual molecules are detected for the majority of the time. As a result, sample quality control is an important aspect of smFRET experiments. The concentration of the sample should be carefully controlled to ensure accurate results. If the sample concentration is too high, then the probability of two (or more) molecules being simultaneously present in the confocal volume is increased. Such events would be indistinguishable from true single-molecule events and would skew the results of any analysis and provide inaccurate results. It is not possible to disentangle single-molecule signals from multi-molecule signals when both types of signals are present. For example, if a single molecule has two conformations (e.g. open and closed), a multi-molecule signal may indicate the average conformation (which does not reflect the physical reality) rather than the two distinct conformations. If the sample concentration is too low, longer acquisitions are required which can cause problems with sample evaporation and/or degradation. Furthermore, fluorescent contamination in solution buffers can result in an intolerable level of noise in the single-molecule measurements. This contamination can manifest either as increased background, reducing the signal-to-noise ratio, or as spuriously fluorescent bursts unrelated to the sample, which can coincide with signal from molecules of interest in the manner described above and reduce the quality of collected data.

The present disclosure provides a solution-based single-molecule fluorescence spectroscopy system (which may simply be referred to herein as “the system”) that can advantageously analyse sample quality and provide a sample quality signal for a user.

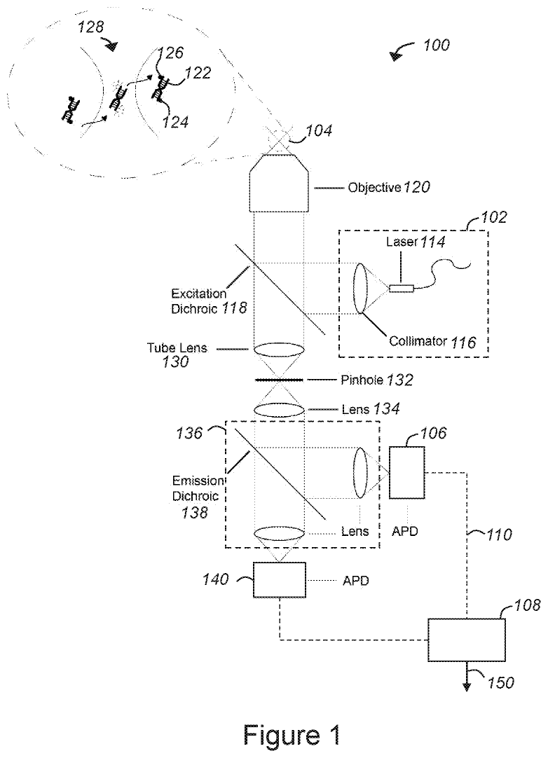

FIG. 1 illustrates a simplified schematic of a solution-based single-molecule fluorescence spectroscopy system 100 according to an embodiment of the present disclosure. In this example, the system is a smFRET system, however other examples may include a two-colour coincident detection system.

The system 100 comprises: an excitation source 102 for illuminating an excitation volume of a fluorescently labelled sample solution 104 with excitation radiation; a detector 106 for detecting fluorescence emission radiation emitted from a detection volume of the fluorescently labelled sample solution 104; and a processor 108. The processor 108 is configured to: receive a detection signal 110 from the detector 106; calculate a sample signal occupancy representing a proportion of time that the detection signal comprises an emission signal from the fluorescently labelled sample; and output a sample quality signal 150 to a user interface based on the sample signal occupancy.

The sample quality signal 150 output by the system 100 can advantageously inform a user whether a sample is of sufficient quality for performing single-molecule experiments and avoid inaccurate experiments resulting from poor sample quality. As discussed below, the sample quality signal may include: the sample signal occupancy; an alert for indicating that the sample signal occupancy is too high and/or that the sample requires dilution; a dilution recommendation; a background fluorescence level; and/or an alert that the background fluorescence is too high.

Exploring the features of FIG. 1 in detail, in this example, the excitation source comprises a laser 114 and a collimator 116. In other examples, the excitation source may comprise other optical illuminators such as LEDs. The laser 114 outputs excitation radiation (i.e. laser light) in the form of a divergent beam. The collimator 116 collimates the divergent excitation radiation into a collimated beam. In some examples, the excitation source 102 may comprise a multi-wavelength source for providing excitation radiation at different wavelengths. The excitation source 102 may comprise multiple lasers and/or may comprise a laser that can emit at different wavelengths. The one or more wavelengths of the excitation source 102 may correspond to an excitation wavelength of a respective fluorescent label of the fluorescently labelled sample 104. In some examples, the system may comprise a two-colour co-incident detection system in which the excitation source provides two excitation beams at different wavelengths simultaneously. In some examples, the system may comprise an alternating laser excitation system in which the excitation source alternates the excitation wavelength between a first wavelength and a second wavelength different from the first wavelength. In some examples, the excitation source may provide a single wavelength.

In some examples, the excitation source may emit one or more wavelengths in the visible range to excite a respective one or more fluorophores at a corresponding excitation wavelength. In some examples, the one or more wavelengths (and corresponding excitation wavelengths) may comprise visible, IR or UV wavelengths or a combination thereof.

In this example, an excitation dichroic mirror 118 is arranged to reflect the collimated excitation radiation towards an objective lens 120. The excitation dichroic mirror 118 is configured to reflect radiation at the one or more wavelengths of the excitation source and transmit radiation at one or more wavelengths of the fluorescence emission radiation emitted from the sample 104. The objective lens 120 focuses the collimated excitation radiation to a near diffraction limited spot defining an excitation volume 128 in the sample solution 104. It will be appreciated that different optical arrangements may be provided to focus the excitation radiation onto the excitation volume 128 of the sample solution 104.

The fluorescently labelled sample solution 104 comprises fluorescently labelled molecules 122, such as DNA or proteins, (freely diffusing) in solution. The solution may comprise a buffer and the buffer may comprise multiple buffer components (e.g. water, TRIS, MgCl2, phosphate etc.). The fluorescently labelled molecules may be labelled with a donor fluorophore 124 and an acceptor fluorophore 126. The donor fluorophore 124 and the acceptor fluorophore 126 can be positioned at specific sites of the molecule to study the conformation of a specific moiety of the molecule. When a fluorescently labelled molecule diffuses into the excitation volume, the excitation radiation may excite the donor fluorophore (and optionally the acceptor fluorophore). FRET occurs when the excitation energy transfers from the donor fluorophore to the acceptor fluorophore resulting in fluorescence emission radiation (i.e. emitted fluorescence light) comprising acceptor emission radiation (at an acceptor emission wavelength) in addition to donor emission radiation (at a donor emission wavelength different to the acceptor emission wavelength). The efficiency of this transfer process from donor emission to acceptor emission scales inversely with the sixth power of the distance between the two fluorophores. Therefore, by measuring the FRET efficiency (e.g. by observing the ratio of the emission of the two fluorophores under excitation of the donor), spatial information can be determined about the molecule. In an alternating laser excitation system, the two wavelengths of the excitation source can correspond to the excitation wavelength of the two fluorophores. The alternating excitation can provide: a first detection signal comprising a FRET signal (donor and acceptor emission) resulting from donor excitation; and a second reference signal corresponding to acceptor only emission resulting from acceptor excitation. Exciting only the acceptor alone can provide confirmation that the acceptor fluorophore is present. In some examples, the processor 108 can compute a FRET correction factor using FRET signal and the second reference signal.

In this example, the objective lens 120 captures (a portion of) the fluorescence emission radiation which passes along an emission optical train comprising: the excitation dichroic mirror 118, a tube lens 130, a pinhole 132, a second collimating lens 134 and detection optics 136. The emission optical train defines a detection volume of the sample from which fluorescence emission radiation can be detected. The overlap of the excitation volume 128 and the detection volume defines a confocal volume within which molecules can be excited and their fluorescent emission detected. The fluorescence emission radiation passes from the objective lens 120 through the excitation dichroic mirror 118 and is focussed by the tube lens 130 onto the pinhole 132. The pinhole 132 rejects fluorescence emission radiation that is not emitted from the focal plane of the objective lens 120. Fluorescence emission radiation that passes through the pinhole 132 is collimated by the second collimating lens 134. The detector optics 136 couple the fluorescence emission radiation onto a sensor element of one or more detectors 106, 140.

In this example, the detector optics 136 include an emission dichroic mirror 138 that reflects fluorescence emission radiation from the donor fluorophore (at the donor emission wavelength) onto a first detector 106 (via a first detector lens) and transmits fluorescence emission radiation from the acceptor fluorophore (at the acceptor emission wavelength) onto a second (acceptor) detector 140 (via a second detector lens). In this way, the first detector 106 detects fluorescence emission radiation from the donor fluorophore and the second detector 140 detects fluorescence emission radiation from the acceptor fluorophore. The first and/or second detector 106, 140 may comprise single photon counters. In this example, both detectors 106, 140 comprise avalanche photodiodes (APDs). In some examples, one or more detectors may comprise a photomultiplier tube for detecting an intensity level rather than an absolute photon count. In some examples, the system 100 may comprise a single detector capable of detecting multiple wavelengths (e.g. the donor emission wavelength and the acceptor emission wavelength). In some examples, each detector may also have a corresponding emission filter (not shown) to filter any signal outside a fluorescence emission band of the corresponding donor/acceptor fluorescence emission radiation.

The detector(s) 106, 140 output the detection signal 110 to the processor 108. The processor may output the detection signal 110 to a display unit (not shown). The detection signal 110 may comprise information relating to a (time dependent) intensity level or photon count detected by the detector(s) 106, 140.

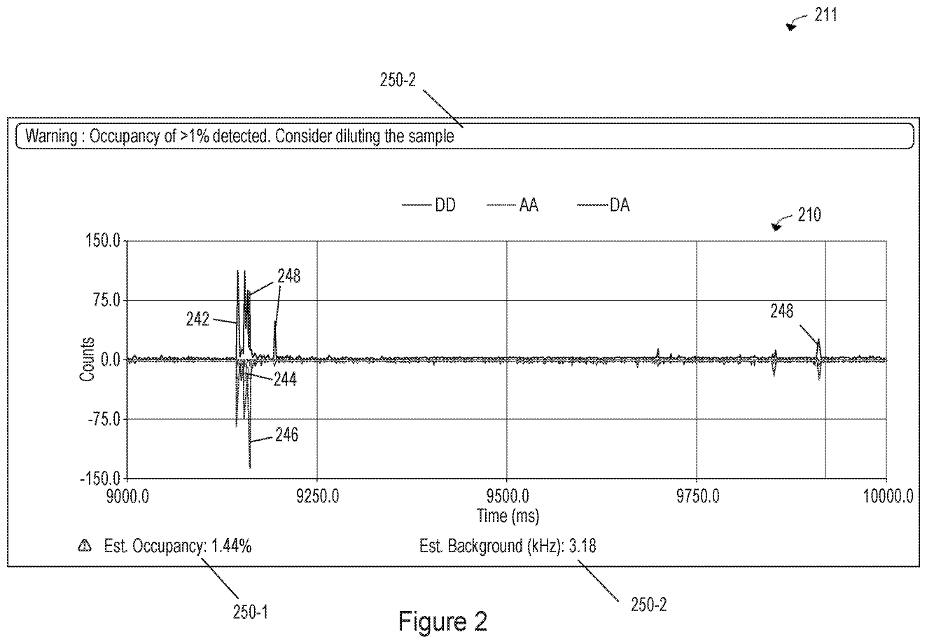

FIG. 2 illustrates an example detection signal 210 output to a user interface 211 of the system of FIG. 1. The example detection signal 210 is shown for a 1-second window.

In this example molecules of the fluorescently labelled sample solution were labelled with: a donor fluorophore comprising ATTO550 with a peak excitation wavelength of 550 nm, excited by donor excitation laser comprising a 520 nm diode laser, and a donor emission wavelength of 576 nm; and an acceptor fluorophore comprising ATTO647n with a peak excitation wavelength of 647 nm, excited by a 638 nm acceptor excitation laser, and an acceptor emission wavelength of 680 nm. A donor emission filter comprising an emission bandpass from 535-607 nm was placed in front of the first detector to filter background radiation (including stray excitation radiation) outside the fluorescence emission band of the donor fluorophore. An acceptor emission filter comprising an emission bandpass was used with the second detector to filter background radiation (including stray excitation radiation) outside the fluorescence emission band of the acceptor fluorophore.

In this example, alternating laser excitation was used (at a rate of 20 kHz). The resulting detection signal 210 comprises a donor-excitation-donor-emission (DXDE) signal 242; a donor-excitation-acceptor-emission signal 244 (DXAE); and an acceptor-excitation-acceptor-emission (AXAE) signal 246. As noted above, acceptor excitation, and the resulting AXAE signal 246 is optional, and can be used as a reference signal. The ratio of the DXDE signal 242 to the DXAE signal 244 can represent a FRET efficiency.

As illustrated in FIG. 2, the detection signal 210 is at a background level for the majority of the 1-second window (for all three signals DXDE, DXAE, AXAE). This corresponds to time when there are no fluorescently labelled molecules within the confocal volume. Burst peaks 248 (for all three signals) can be seen corresponding to periods of time when a single molecule: diffuses into the confocal volume, is excited by the excitation radiation and produces fluorescence emission radiation which is detected by the detectors to provide the detection signal. The burst peaks may be referred to as a sample emission signal of the detection signal. The detection signal at other periods of time may be referred to as a background signal.

The sample signal occupancy corresponds to the relative portion (or proportion) of time that the detection signal 210 comprises a burst peak 248/sample emission signal (resulting from fluorescence emission radiation). The sample signal occupancy may be defined as a percentage of time that at least one fluorescently labelled molecule was within the confocal volume (and producing detectable fluorescence emission radiation). The sample signal occupancy may correspond to a percentage or ratio. The sample signal occupancy provides a relative measure of the concentration of the sample. As noted above, controlling sample concentration is important for single-molecule systems to ensure that the detection signal truly corresponds to single-molecules and does not include simultaneous signals from multiple molecules which can lead to grossly inaccurate data.

The processor of the system is configured to calculate the sample signal occupancy from the detection signal 210. In some examples, the processor may divide the detection signal into a plurality of time bins. In some examples, the processor may divide the detection signal into 1 ms time bins, e.g. 1000×1 ms time bins for a 1-second signal-sample. For each time bin, the processor can determine the time bin to comprise a sample emission signal if a signal level (e.g. intensity level or total photon count) of the detection signal 210 within the time bin exceeds a sample identification threshold. The sample detection threshold may comprise an intensity level threshold or a photon count threshold, for example 30 photons for a 1 ms time bin. The processor may determine the time bin to comprise a background signal if the signal level in the time bin is less than or equal to the sample identification threshold. For a two-detector system (one monitoring donor emission, one monitoring acceptor emission), the processor may: (i) determine a time bin to comprise a sample emission signal if the signal level of the detection signal from either detector exceeds a respective sample identification threshold for each detector; and (ii) determine the time bin to comprise a background signal if the signal level of the detection signal from both detectors is less than or equal to the respective sample identification threshold.

The processor can determine the sample signal occupancy as the number of time bins comprising a sample emission signal divided by the total number of time bins in the plurality of time bins (e.g. 15 sample bins/ 1000 total bins =1.5 % sample signal occupancy).

In some examples, the processor may calculate the sample signal occupancy in a different manner. For example, the processor may: perform a peak detection algorithm to identify each burst peak 248 corresponding to fluorescence emission radiation; determine a pulse width of each burst peak; and determine the sample signal occupancy as the sum of the pulse widths divided by the time period of the detection signal sample (e. g 1-second time window).

In this example, the processor outputs the sample quality signal 250 to the user interface 210. In this example, the sample quality signal 250 includes: the sample signal occupancy 250-1 expressed as a percentage; and an alert signal 250-2 for indicating that the sample signal occupancy is too high and recommending dilution of the sample solution.

In some examples, the processor may determine that the sample signal occupancy is too high by comparing the sample signal occupancy to an upper occupancy threshold. A sample signal occupancy of 1 % has been found to provide reliable smFRET signals and result in sufficiently few multi-molecule signals to ensure that the detection signal reliably provides single-molecule results. In some examples, the upper occupancy threshold may comprise 1 % or may comprise a value greater than 1 % such as 1.1 % or 1.2 %. In some examples, the processor may set the upper occupancy threshold based on user input.

The processor may output the alert signal 250-2 if the sample signal occupancy exceeds the upper occupancy threshold. The alert signal 250-2 may comprise a visual, audible and/or tactile signal. A visual alert signal may comprise: an indication that the occupancy is too high; a recommendation to dilute the sample solution; and/or a recommended dilution value. The processor may calculate the recommended dilution value based on a ratio of the sample signal occupancy and a target sample signal occupancy. For example, if the sample signal occupancy is 3% and the target sample signal occupancy is 1 %, the processor may calculate the recommended dilution value as a 3-fold dilution.

In some examples, the system may comprise a motorised sample stage suitable for a multi-well sample comprising a multi-well plate with a sample solution in each well. Different wells (e.g. columns or rows of wells) of the multi-well sample may comprise different concentrations of sample solutions (e.g. different amounts of buffer). If the sample quality signal 250 indicates that the sample signal occupancy is too high for a sample solution in a first well, the system may adjust the motorised sample stage to test a second well with a lower sample concentration. In this way, the system may lower a concentration of the fluorescently labelled sample solution if the sample signal occupancy exceeds the upper occupancy threshold.

In some examples, the system may be suitable for a microfluidics-based sample holder in which a first microfluidics supply line may provide a buffer solution to a sample well and a second microfluidics supply line may provide the fluorescently labelled molecules to the sample well. If the sample quality signal indicates that the sample signal occupancy is too high, the system may increase a flow from the first microfluidics supply line to lower the concentration of the sample solution. In this way, the system may lower a concentration of the fluorescently labelled sample solution if the sample signal occupancy exceeds the upper occupancy threshold.

In some examples, the processor may compare the sample signal occupancy to a lower occupancy threshold. The sample quality signal may comprise an alert signal if the sample signal occupancy is less than the lower occupancy threshold. The sample signal occupancy being too low may indicate that the sample concentration is too low or that a problem has occurred in the fluorescent labelling process. The alert signal may comprise: an indication that the sample signal occupancy is too high; a recommendation to increase a concentration of the fluorescently labelled sample solution; and/or an indication that no fluorescence peaks have been detected (if the sample signal occupancy equals zero).

In some examples, the sample quality signal 250 may include a background fluorescence level 250-3. The processor can calculate the background fluorescence level 250-3 based on the time bins that comprise a background signal (in other words, the time bins that do not include a sample emission signal). In some examples, the processor may calculate the background fluorescence level 250-3 based on an average background signal for a background time bin. If burst peak detection is used, the processor may determine the background fluorescence level 250-3 by averaging the signal level of regions of the detection signal that do not include a burst peak 248. In this example, the background fluorescence level 250-3 is expressed as a number of photon counts per second (Hz) and is 3.18 kHz. In some examples, the background fluorescence level 250-3 may be expressed as an average intensity level over the time bins that comprise a background signal.

In this example, the sample quality signal includes the background fluorescence level 250-3. In some examples, the processor may determine that the background fluorescence level 250-3 is too high by comparing the background fluorescence level 250-3 to a background level threshold. A background fluorescence level 250-3 less than 10 kHz and, in particular, less than 3 kHz, has been found to produce good smFRET results with high sensitivity. In some examples, the background level threshold may comprise a value between 3 kHz and 10 kHz. In some examples, the processor may set the background level threshold based on user input. The sample quality signal may include a background alert signal if the background fluorescence level 250-3 exceeds the background level threshold. The background alert signal may comprise an indication that the fluorescence background level is too high and/or a recommendation to re-prepare the sample solution buffer. Background fluorescence can result from fluorescence contamination in the buffer of the fluorescently labelled buffer solution. The contamination can arise from many sources such as each buffer component of the buffer solution, contaminated sample holders, buffer solution receptacles, personnel etc.

The disclosed systems and methods can advantageously monitor the sample solution 104 in real-time and provide a real-time sample quality signal for indicating: the sample signal occupancy, the background fluorescence level 250-3 and/or a corresponding alert to a user. In this way, the user can immediately identify if the sample quality is insufficient and take remedial action (dilution or re-prepare) before collecting data.

Although the illustrated example describes the processor calculating the sample signal occupancy and the background fluorescence level 250-3 for a 1-second window of the detection signal 210 it will be appreciated that longer or shorter time windows may be used. In some examples, the processor may calculate the sample signal occupancy and/or the background fluorescence level 250-3, and update and output the sample quality signal on a continuous or semi-continuous (periodic) basis. Providing the sample quality signal 250, particularly the sample signal occupancy, on a continuous or semi-continuous basis can advantageously provide an indication of changes to sample viability over the course of an experiment (e.g. due to evaporation of the buffer causing an increase in the concentration).

In some examples, the processor may calculate the sample signal occupancy and/or the background fluorescence level 250-3 for every time window (e.g. 1-second window). The processor may update and output the sample quality signal for every time window or may update and/or output the sample quality signal as an average over a number of time windows. For example, the processor may calculate the sample signal occupancy and/or the background fluorescence level 250-3 for every 1-second time window and output the sample quality signal as a rolling 5-second average over 5×1-second time windows.

When the user is running a single-molecule fluorescence spectroscopy experiment the disclosed system can analyse the incoming photon arrival times and estimate the sample signal occupancy and average background count rates (background fluorescence level) and output both parameters to a user interface 211. If either parameter is deemed to be larger than is acceptable for reliable data analysis (>1% for sample signal occupancy or >3-10 kHz for background count rates) the system can output a warning or alert to the user interface 211.

The one or more processors may be located locally with the system or remote to the system (e.g. on a server or on a cloud computing environment) or a mixture of the two. The one or more processors may be part of a computing system running software for controlling the components of the system.

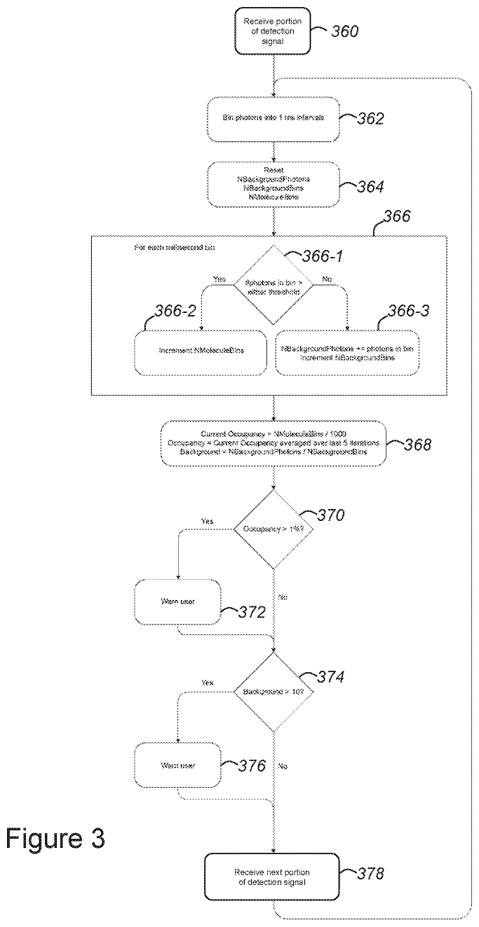

FIG. 3 illustrates a method of determining a sample quality of a fluorescently labelled sample solution in a single-molecule fluorescence spectroscopy system according to an embodiment of the present disclosure. The method may be performed by the processor, or more generally the system, of FIG. 1.

A first step 360 comprises receiving at least a portion (a 1-second sample in this example) of a detection signal from the one or more detectors of the system.

A second step 362 comprises dividing the portion of the detection signal into time bins, which in this example comprise 1000×1 ms time bins.

A third step 364 comprises resetting: a background photon counter, NBackgroundPhotons; a background bin counter, NBackgroundBins; and a sample bin counter, NSampleBins.

A fourth step 366 comprises, for each time bin, at a first sub-step 366-1 determining if a signal level of the detection signal (number of photons) in the time bin exceeds a sample identification threshold. A second sub-step 366-2 comprises (for each time bin) incrementing, by one, the sample bin counter, NSampleBins, if the signal level of the detection signal exceeds the sample identification threshold. A third sub-step 366-3 comprises: (for each time bin) incrementing, by one, the background bin counter, NBackgroundBins; and increasing the background photon counter, NBackgroundPhotons, by the signal level (number of photons) in the time bin, if the signal level of the detection signal is less than the sample identification threshold.

A fifth step 368 comprises calculating: the sample signal occupancy by dividing the sample bin counter by the total number of time bins (NSampleBins/1000 in this example); an average sample signal occupancy comprising an average of the sample signal occupancy over multiple previous iterations (five iterations in this example) of the method; and a background fluorescence level by dividing the background photon counter, NBackgroundPhotons, by the background bin counter, NBackgroundBins.

A sixth decision step 370 comprises determining if the average sample signal occupancy is greater than the upper occupancy threshold, which in this example is 1%. If the average sample signal occupancy is greater than the upper occupancy threshold, the method proceeds to seventh step 372 comprising outputting an alert to a user interface before proceeding to an eighth step 374. If the average sample signal occupancy is less than the upper occupancy threshold, the method proceeds directly to the eighth step 374.

The eighth step 374 comprises determining if the fluorescence background level exceeds a background level threshold. If the fluorescence background level exceeds the background level threshold, the method proceeds to ninth step 376 comprising outputting a background alert to the user interface before proceeding to a tenth step 378. If the background fluorescence level does not exceed the background level threshold, the method proceeds directly to the tenth step 378.

The tenth step 378 comprises receiving a next portion of the detection signal and returning to the second step 362.

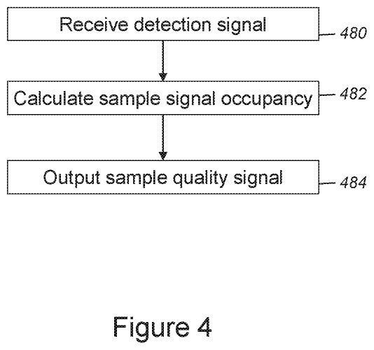

FIG. 4 illustrates a method of determining a sample quality of a fluorescently labelled sample solution in a single-molecule fluorescence spectroscopy system according to an embodiment of the present disclosure. The method may be performed by the processor, or more generally the system, of FIG. 1.

A first step 480 comprises receiving a detection signal from the detector of the system. A second step 482 comprises calculating a sample signal occupancy representing a proportion of time that the detection signal comprises a sample emission signal from the fluorescently labelled sample solution. A third step 484 comprises outputting a sample quality signal based on the sample signal occupancy.

Throughout the present specification, the descriptors relating to relative orientation and position, such as “horizontal”, “vertical”, “top”, “bottom” and “side”, are used in the sense of the orientation of the system as presented in the drawings. However, such descriptors are not intended to be in any way limiting to an intended use of the described or claimed invention.

It will be appreciated that any reference to “close to”, “before”, “shortly before”, “after” “shortly after”, “higher than”, or “lower than”, etc, can refer to the parameter in question being less than or greater than a threshold value, or between two threshold values, depending upon the context.

1. A solution-based single-molecule fluorescence spectroscopy system comprising:
an excitation source for illuminating an excitation volume of a fluorescently labelled sample solution with excitation radiation;
a detector for detecting fluorescence emission radiation emitted from a detection volume of the fluorescently labelled sample solution;
one or more processors configured to:
receive a detection signal from the detector;
calculate a sample signal occupancy representing a proportion of time that the detection signal comprises a sample emission signal from the fluorescently labelled sample solution; and
output a sample quality signal based on the sample signal occupancy.

2. The system of claim 1, wherein the sample quality signal comprises the sample signal occupancy.

3. The system of claim 1, wherein:
the one or more processors are configured to compare the sample signal occupancy to an upper occupancy threshold; and
the sample quality signal comprises an alert signal if the sample signal occupancy exceeds the upper occupancy threshold.

4. The system of claim 3, wherein the alert signal comprises an indication that the sample signal occupancy is too high and/or a recommendation to dilute the fluorescently labelled sample solution.

5. The system of claim 3, wherein the one or more processors are configured to calculate a recommended dilution value based on the sample signal occupancy and wherein the alert signal indicates the recommended dilution value.

6. The system of claim 3, wherein the system is configured to lower a concentration of the fluorescently labelled sample solution if the sample signal occupancy exceeds the upper occupancy threshold.

7. The system of claim 6, wherein the system comprises a microfluidics sample holder and the system is configured to lower the concentration of the fluorescently labelled sample solution by increasing a flow of a first microfluidics supply line supplying a buffer solution and/or decreasing a flow of a second microfluidics supply line supplying fluorescently labelled molecules.

8. The system of claim 6, wherein the system is suitable for a multi-well sample, wherein different wells of the multi-well sample comprise different concentrations of fluorescently labelled sample solutions and wherein the system is configured to lower the concentration of the fluorescently labelled sample solution by positioning a well with a relatively low concentration sample solution in the excitation volume.

9. The system of claim 3, wherein:
the one or more processors are configured to compare the sample signal occupancy to a lower occupancy threshold; and
the sample quality signal comprises an alert signal if the sample signal occupancy is less than the lower occupancy threshold.

10. The system of claim 9, wherein the alert signal comprises: an indication that the sample signal occupancy is too low; a recommendation to increase a concentration of the fluorescently labelled sample solution; and/or an indication that no fluorescence peaks have been detected.

11. The system of claim 1, wherein the one or more processors are configured to calculate the sample signal occupancy by:
dividing the detection signal into a plurality of time bins;
for each time bin, determine the time bin to comprise a sample emission signal from the fluorescently labelled sample if a signal level of the detection signal exceeds a sample identification threshold; and
determine the sample signal occupancy as the number of time bins comprising an emission signal divided by the total number of time bins in the plurality of time bins.

12. The system of claim 1, wherein the one or more processors are configured to:
perform a peak detection algorithm to identify one or more burst peaks of the detection signal corresponding to fluorescence emission from the fluorescently labelled sample;
determine a pulse width of each burst peak; and
determine the sample signal occupancy as the sum of the pulse widths divided by a time period of the detection signal.

13. The system of claim 1, wherein:
the one or more processors are configured to determine a fluorescence background level based on a signal level of a proportion of the detection signal that does not comprise a sample emission signal; and
the one or more processors are configured to output the sample quality signal based on the sample signal occupancy and the background fluorescence level.

14. The system of claim 1, wherein the one or more processors are configured to:
divide the detection signal into a plurality of time bins;
for each time bin,
determine the time bin to comprise a sample emission signal from the fluorescently labelled sample if a signal level of the detection signal exceeds a sample identification threshold; and
determine the time bin to comprise a background signal if the signal level of the detection signal is less than or equal to the sample identification threshold;
determine the sample signal occupancy as the number of time bins comprising an emission signal divided by the total number of bins in the plurality of time bins;
determine a fluorescence background level based on an average signal level of the time bins comprising a background signal; and
output the sample quality signal based on the sample signal occupancy and the background fluorescence level.

15. The system of claim 1, wherein the one or more processors are configured to:
perform a peak detection algorithm to identify one or more burst peaks of the detection signal corresponding to fluorescence emission from the fluorescently labelled sample; and
determine a background fluorescence level based on an average signal level of regions of the detection signal that do not include a burst peak.

16. The system of claim 1, wherein the sample quality signal comprises the background fluorescence level.

17. The system of claim 1, wherein:
the one or more processors are configured to compare the fluorescence background level to a background level threshold; and
the sample quality signal comprises a background alert signal if the fluorescence background level is greater than the background level threshold.

18. The system of claim 17, wherein the background alert signal comprises an indication that the fluorescence background level is too high and/or a recommendation to re-prepare the sample solution buffer.

19. The system of claim 1, wherein the processor is configured to output the sample quality signal on a continuous or semi-continuous basis.

20. A method of determining a sample quality of a fluorescently labelled sample solution in a single-molecule fluorescence spectroscopy system, the method comprising:
receiving a detection signal from the detector of the system;
calculating a sample signal occupancy representing a proportion of time that the detection signal comprises a sample emission signal from the fluorescently labelled sample solution; and
outputting a sample quality signal based on the sample signal occupancy.

21. (canceled)
